(19) United States
(12) Patent Application Publication
(10) Pub. No.: US 2005/0149752 A1
(43) Pub. Date: Jul. 7, 2005

(54) System and method for tracking laptop computers

(76) Inventors: Robert K. Johnson, Detroit, MI (US); Susan M. Kudek, Detroit, MI (US)

Correspondence Address: THE INVENTORS NETWORK, INC., 332 ACADEMY STREET, CARNEGIE, PA, 15106, US

(21) Appl. No.: 10/746,920

(22) Filed: Dec. 29, 2003

(51) Int. Cl. H04L 9/00

(52) U.S. Cl. 713/201

(57) ABSTRACT

A laptop computer tracking system is disclosed for tracking stolen laptop computers or hard drives includes a miniaturized GPS transmitter integrated with the software and hardware of the laptop computer, a password access screen, a password disabling screen for permitting hard drive maintenance, and an interlocking device or mechanism for locking the hard drive and preventing its installation in any other computer. The system is activated when a non-authorized user powers up the laptop computer or removes the hard drive thereby activating the transmitter to send a signal to a laptop monitoring station whereupon monitoring station personnel will employ the worldwide GPS to locate the stolen laptop or hard drive and contact the owner for further instructions.

### FIELD OF THE INVENTION

The present invention pertains to tracking systems, and, more particularly, pertains to a tracking system for laptop computers integrated with GPS technology.

### BACKGROUND OF THE INVENTION

The theft of laptop computers is an increasingly serious problem in modern society. With the rise of the 24 hour global economy, laptop computers are in continuous use to meet the demands and needs of businesses around the globe. In order to provide round-the-clock service to computer users, usb ports, communication jacks, and internet connections have been provided at coffee shops and kiosks, airline terminals and bus stops, and on airliners, cruise ships, and subways.

However, with the increased use of laptops in wide ranging situations and at all hours of the day or night comes their increased exposure and opportunities for theft. The protection of data stored on the devices is thus an acute concern in view of such widespread opportunities for theft. Moreover, the tracking and recovery of such stolen laptops is also an enormous problem. For example, there was a case where a laptop owned by the State Department was stolen and knowledge of the theft was not revealed until some time after the fact. Had the laptop contained classified information, the harm could have been immense if such information had been retrieved by undesirable sources. With the incalculable value of competitive information that is stored on the laptop of any Fortune 500 CEO or CFO, the security of laptops and the ability to quickly and expeditiously track and recover them if stolen is a paramount concern and problem. In addition, it is generally acknowledged that up to 90% of all desk top and portable devices are not consistently backed up, and therefore if such devices are lost or stolen, there is a high likelihood that data stored therein will be lost.

In view of the above problems, the prior art discloses a number of methods and devices for tagging and recovering electronic devices.

The Kriofsky et al. patent (U.S. Pat. No. 3,859,624) discloses an interrogator-responder device placed, for example, on a roadway for generating power fields and receiving coded information from a responder tag.

The Williams patent (U.S. Pat. No. 4,471,344) discloses a system for detecting the presence of an article within a surveillance area and includes a transmitter, a transponder, a receiver and an alarm responsive to the receiver.

The Geiszler et al. patent (U.S. Pat. No. 5,099,227) discloses a remotely powered batteryless portable device having circuitry capable of generating both an electrostatic and electromagnetic field for activating a portable responsive device.

The Ward et al. patent (U.S. Pat. No. 6,046,676) discloses a tag incorporated into a computer and which is interrogated by the computer through rectified radio frequency signals.

The Pruett et al. patent (U.S. Pat. No. 6,154,790) discloses a system for retrieving and reporting serial numbers of hard disk drives in a computer system and copying the serial numbers by a radio frequency enabled memory.

Despite the ingenuity of the above devices there remains a need for a tracking system that utilizes the most advanced tracking technology available for tracking laptop computers over extensive geographic areas.

### SUMMARY OF THE INVENTION

The present invention comprehends a laptop computer tracking system for tracking stolen laptops that utilizes miniaturized GPS technology in communication with the worldwide deployment of GPS satellites. The system utilizes the global orbital positioning of currently 24 GPS satellites deployed by the United States Defense Department to track stolen laptops. The laptop computer tracking system includes software for recognizing on/off states of the computer, a built-in interlocking device for selectively locking the hard drive to prevent data theft or theft of the actual hard drive, and a miniaturized GPS transmitter for transmitting RF signals to an monitoring station. The monitoring station will then locate the stolen laptop computer using the worldwide GPS system.

It is an objective of the present invention to provide a laptop computer tracking system capable of tracking a stolen laptop computer or hard drive throughout the world.

It is another objective of the present invention to provide a laptop computer tracking system capable of being initiated immediately upon removal of the hard drive in order to disable the hard drive Yet another objective of the present invention is to provide a laptop computer tracking system that has the flexibility to be deactivated for removing the hard drive for maintenance.

Yet still another objective of the present invention is to provide a laptop computer tracking system capable of continuously transmitting a locating signal to a monitoring station even if the particular laptop computer is powered off.

Still yet another objective of the present invention is to provide a laptop computer tracking system having an internal transmitter that remains in a deactivated off state until the particular laptop computer is turned on thereby conserving battery power.

These and still other objects, features, and advantages of the present invention will become apparent to those skilled in the art upon a perusal of the following detailed description when read in concert with the appended drawings.

### BRIEF DESCRIPTION OF THE DRAWINGS

FIG. 1 is a perspective view of a representative laptop computer containing the miniaturized GPS transmitter;

FIG. 2 is a schematic plan view of a flowchart illustrating the sequence of steps that are activated by the laptop computer tracking system when a non-authorized user attempts to gain access to the laptop computer;

FIG. 3 is a schematic plan view of a flowchart illustrating the sequence of steps that are activated by the laptop computer tracking system when the hard drive is removed by an non-authorized user;

FIG. 4 is a sectioned elevational view of the initial screen presentation for allowing access to the laptop computer; and

FIG. 5 is a sectioned elevational view of the screen presentation for deactivating the laptop computer tracking system through a password protected menu for allowing hard drive removal.

### DETAILED DESCRIPTION OF THE PREFERRED EMBODIMENT

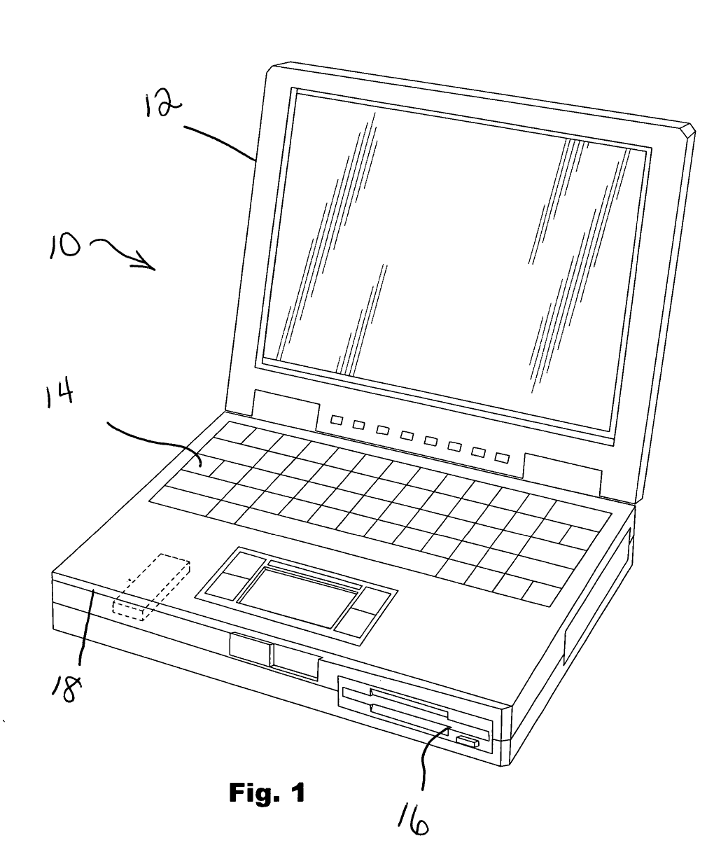

Illustrated in FIGS. 1-5 is a laptop computer tracking system for tracking lost or stolen laptop computers by incorporating the system with one or more ground-based monitoring stations and accompanying monitoring personnel, and the worldwide GPS satellite tracking and location system. In addition, the laptop computer tracking system of the present invention also includes the ability to track and locate stolen hard drives that have been removed from the particular laptop computer. The laptop computer tracking system includes a password authorization means for determining whether or not, within a fixed time period, the correct password has been entered and the user is authorized or not, and a password deactivation or disabling means for deactivating the tracking system so that legitimate maintenance, such as removal and repair of the hard drive, can be undertaken. Both the authorization and deactivation means will have separate screen presentations in the preferred embodiment of the invention.

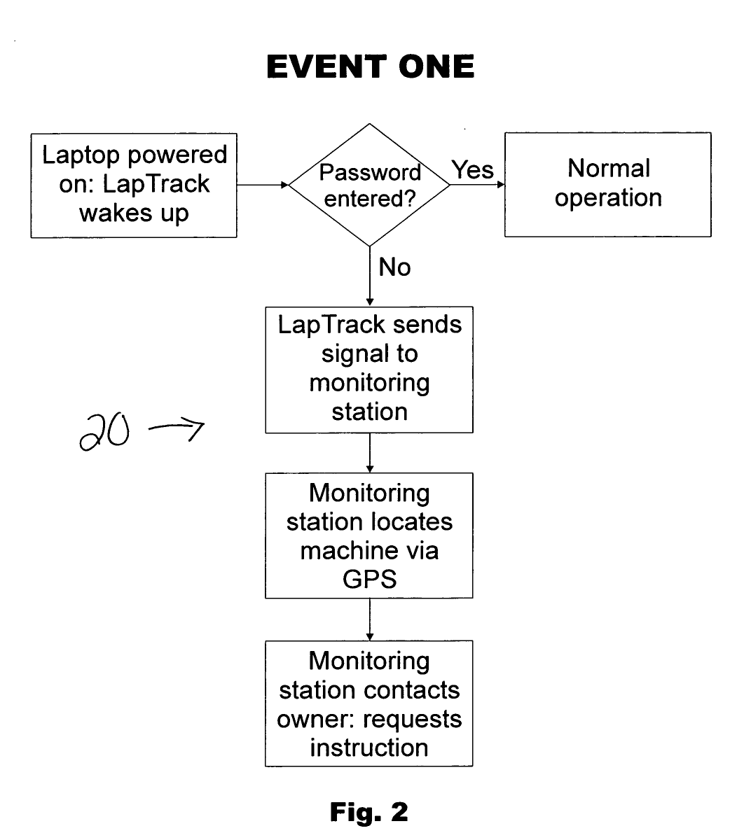

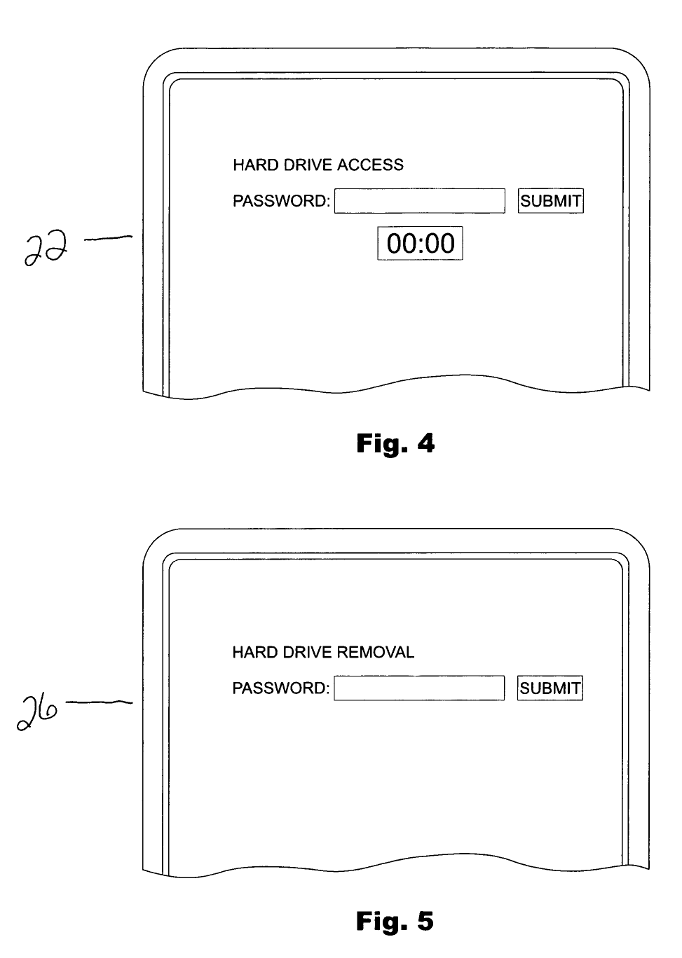

Shown in FIG. 1 is a representative laptop computer 10 that includes a screen or monitor 12, a keyboard 14, a floppy disk or cd drive 16 and an internal, miniaturized GPS transmitter 18. In FIG. 2 a password authorization means in the form of an algorithm or flowchart 20 is illustrated that is activated for one sequence of events in tracking the stolen laptop computer 10. The password authorization screen 22 of FIG. 4 would be a representative example of the initial screen for gaining access to the computer 10. The first step in the password authorization sequence of FIG. 2 is to power the laptop computer 10 on thereby activating the circuitry for the miniaturized GPS transmitter 18. With reference to FIGS. 2 and 4, the appropriate and registered user (or users) would enter his or her correct password within a specified time period. Successful password entry then leads to the normal operation of the computer 10.

In the alternate scenario, if the individual doesn't enter the correct pass word within the specified time period, the circuitry of the laptop computer tracking system integrated with the GPS transmitter 18 is activated for locking the hard drive and transmitting an RF signal to the proximate monitoring station. Through digital telecommunications means the employees or personnel at the monitoring station will then utilize the worldwide GPS system to locate the lost or stolen laptop computer 10. The last step in the process will be for the monitoring station personnel to contact the owner of the laptop 10 for requesting further instructions. It should be noted that even if the laptop computer 10 is turned off to evade detection, the GPS transmitter 18 would continue to transmit signals to the monitoring station. The laptop computer tracking system, and, specifically, the transmitter 18, continues signal transmission even if the laptop computer 10 is turned off.

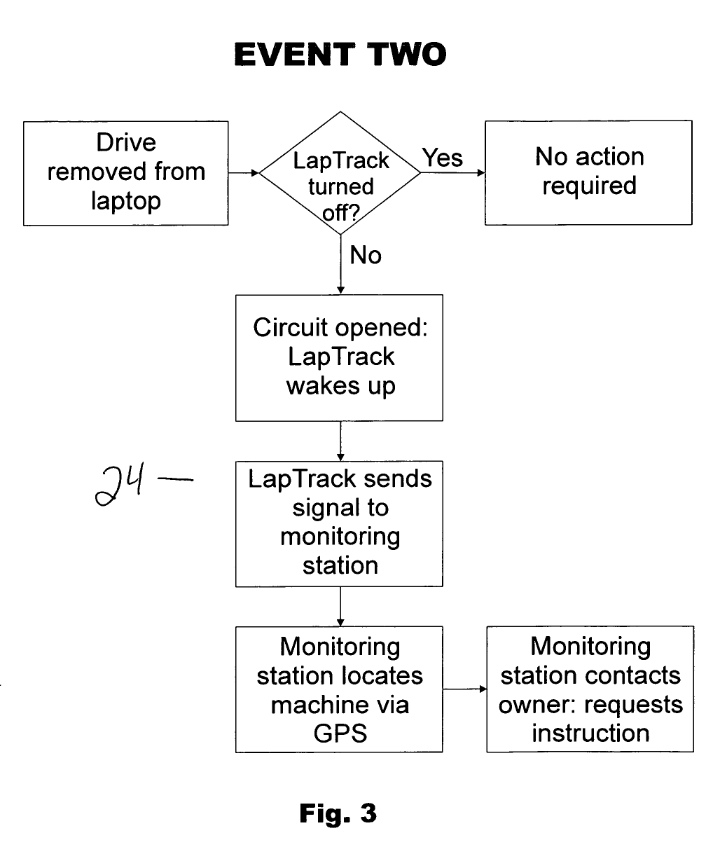

With reference to FIGS. 3-5, a second sequence of events is described by the hard drive activation flowchart or algorithm 24 pertaining to the unauthorized removal of the hard drive from the laptop computer 10. It should be noted that the hard drive can be removed for maintenance purposes without activating the laptop computer tracking system by deactivating the laptop computer tracking system through a password disabling screen or password protected menu. The initial hard drive password protected removal screen 26 is shown in FIG. 5.

Thus, with regard to the flowchart 24 of FIG. 3, if the hard drive is removed from the laptop computer 10, an internal interlocking device will disable the hard drive to prevent its installation in another computer. Internal circuitry will then activate the laptop computer tracking system to commence signal transmission by the GPS transmitter 18 to the monitoring station. The monitoring station would then locate the stolen or missing hard drive through the global GPS system, and upon locating the stolen or missing hard drive, the monitoring station personal would contact the owner requesting further instructions.

It should be additionally noted that the present invention incorporates only one-way transmission—that is, from the miniaturized GPS transmitter 18 to the monitoring station. However, the invention could be expanded to include two-way transmission that would effectively locate laptop computers that are simply lost rather than stolen. Several possible methods could be employed to accomplish this result: first, the laptop computer tracking system could be activated by signal transmission from the monitoring station without requiring powering up of the laptop computer or removal of the hard drive; or, the second method would be to maintain the power on status of the transmitter at all times while avoiding the draining of the laptop computer's battery. Both approaches require further technical innovation.

While the foregoing describes the invention in terms of a preferred embodiment, it will be recognized by those skilled in the art that various additional modifications and alterations may be made without departing from the spirit and scope of the invention or the following appended claims.

1. A laptop computer tracking system for integration with a monitoring station and the global GPS system for locating stolen computers and hard drives, comprising:
a GPS transmitter disposed within the computer and normally in an off state until the computer is powered on, the GPS transmitter capable of continuously transmitting a signal to the monitoring station when the computer is powered on;
a password access sequence for determining within an fixed time period whether the correct password is entered and the user is an authorized or unauthorized user for that computer;
a tracking system deactivation password sequence for deactivating the laptop computer tracking system so that the hard drive of that respective computer can be removed for maintenance;
an interlocking device interconnected to the hard drive of the computer for locking the hard drive and making the hard drive unusable after the fixed time period for entry of the correct password elapses and the correct password has not been entered; and
whereupon failure to enter the correct password within the fixed time period causes the tracking system to lock the hard drive and activate the GPS transmitter to continuously transmit signals to the proximate monitoring station for evaluation so that the monitoring station can employ the worldwide GPS system for locating the stolen computer.

2. A laptop computer tracking system for integration with a monitoring station and the worldwide GPS system for locating hard drives removed from laptop computers by unauthorized users, comprising:
an interlocking device interconnected to the hard drive of the computer and capable of disabling the hard drive if the hard drive is removed by an unauthorized user;
a GPS transmitter disposed within the computer and interconnected with the hard drive so that removal of the hard drive causes the activation of the GPS transmitter; and
whereupon activation of the GPS transmitter causes the GPS transmitter to continuously transmit signals to the proximate monitoring station for evaluation so that the monitoring station can then utilize the worldwide GPS system for locating the missing hard drive.

3. A laptop computer tracking system for integration with monitoring stations and the worldwide GPS system for locating stolen computers and missing hard drives, comprising:
password authorization means for determining whether access to the computer is by an authorized or unauthorized user;
password deactivation screen means for allowing an authorized user to deactivate the laptop computer tracking system so that hard drive maintenance can occur;
a GPS transmitter disposed within the computer and normally in an off state until the computer is powered on, the GPS transmitter capable of continuously transmitting a signal to the monitoring station in order to facilitate the location of the computer or hard drive;
hard drive interlocking means for disabling the hard drive if the hard drive is removed, the hard drive interlocking means interconnected to the GPS transmitter for activating the GPS transmitter to transmit signals to the monitoring station; and
whereupon determination by the password authorization means of an unsuccessful attempt at computer access causes the locking of the hard drive and the activation of the GPS transmitter to transmit signals to the monitoring station so that the signals can be evaluated by the monitoring station and as a result the monitoring station can employ the worldwide GPS system to locate the stolen computer or missing hard drive.
